(19) United States
(12) Patent Application Publication
(10) Pub. No.: US 2020/0169688 A1
(43) Pub. Date: May 28, 2020

(54) VIDEO/AUDIO REPRODUCTION DEVICE, VIDEO/AUDIO REPRODUCTION METHOD, AND RECORDING MEDIUM

(71) Applicant: SOCIONEXT INC., Kanagawa (JP)

(72) Inventor: Shuji MIYASAKA, Yokohama (JP)

(21) Appl. No.: 16/775,198

(22) Filed: Jan. 28, 2020

Related U.S. Application Data
(63) Continuation of application No. PCT/JP2017/027745, filed on Jul. 31, 2017.

(51) Int. Cl. H04N 5/57; H04N 5/60

(52) U.S. Cl. CPC H04N 5/57; H04N 5/60

(57) ABSTRACT

A video/audio reproduction device that adjusts a common parameter associated with a plurality of individual parameters to adjust image quality and sound quality includes: a parameter output unit that accepts an input of the common parameter and outputs a first individual parameter and a second individual parameter that are associated with the common parameter inputted, among the plurality of individual parameters; an image quality adjustment unit that adjusts the image quality in accordance with the first individual parameter outputted; and a sound quality adjustment unit that adjusts the sound quality in accordance with the second individual parameter outputted, wherein the first individual parameter is at least one image quality adjustment parameter that changes in response to changes in the common parameter, and the second individual parameter is at least one sound quality adjustment parameter that changes in response to changes in the common parameter.

### CROSS REFERENCE TO RELATED APPLICATION

This is a continuation application of PCT Patent Application No. PCT/JP2017/027745 filed on Jul. 31, 2017, designating the United States of America. The entire disclosure of the above-identified application, including the specification, drawings and claims is incorporated herein by reference in its entirety.

### FIELD

The present disclosure relates to a video/audio reproduction device, a video/audio reproduction method, and a recording medium.

### BACKGROUND

With reference to FIG. 1, “the 2015 NHK Japanese Time Use Survey” conducted by NHK Broadcasting Culture Research Institute shows, for example, people aged 70 and over among the elderly generations spend much longer time on television viewing than younger generations. With reference to FIG. 2, another survey conducted by the Ohara Memorial Institute for Science of Labor shows that decline in vision and hearing is more serious than other aging-related decline in physical function. With reference to FIG. 3A and FIG. 3B, a survey conducted by REJOB Co., Ltd. shows that both visual and hearing functions decline in a similar pattern with increasing age. Against these backdrops, a technological development is ongoing for adjusting image quality to suit the elderly. For example, WO2016/017081 (Patent Literature (PTL) 1) discloses an image correction device that applies enhancement on at least one of the luminance gradation, the luminance contour, and the color tone for image correction. Another technological development is also ongoing for adjusting sound quality to suit the elderly. For example, Japanese Patent No. 5149991 (PTL 2) discloses a voice reproduction device that changes the frequency characteristics of a voice signal in accordance with an increase in the voice volume.

### SUMMARY

### Technical Problem

As shown in FIG. 3A and FIG. 3B, visual and hearing functions have a similar declining pattern in that both of such functions monotonically decline with increasing age, and significantly decline especially in people's late 50s. As shown in PTL 1 and PTL 2, however, there is no technology for adjusting image quality and sound quality in conjunction with each other to suit the physical condition of a viewer.

The present disclosure provides a video/audio reproduction device, a video/audio reproduction method, and a recording medium that facilitate viewer's adjusting image quality and sound quality to suit such viewer.

### Solution to Problem

The video/audio reproduction device according to one aspect of the present disclosure is a video/audio reproduction device that adjusts a common parameter associated with a plurality of individual parameters to adjust image quality and sound quality. Such video/audio reproduction device includes: a parameter output unit that accepts an input of the common parameter and outputs a first individual parameter and a second individual parameter that are associated with the common parameter inputted, among the plurality of individual parameters; an image quality adjustment unit that adjusts the image quality in accordance with the first individual parameter outputted; and a sound quality adjustment unit that adjusts the sound quality in accordance with the second individual parameter outputted. Here, the first individual parameter is at least one image quality adjustment parameter that changes in response to changes in the common parameter, and the second individual parameter is at least one sound quality adjustment parameter that changes in response to changes in the common parameter.

The video/audio reproduction method according to another aspect of the present disclosure is a video/audio reproduction method, including: accepting an input of a common parameter associated with a plurality of individual parameters; outputting a first individual parameter and a second individual parameter that are associated with the common parameter inputted, among the plurality of individual parameters; adjusting image quality in accordance with the first individual parameter outputted; and adjusting sound quality in accordance with the second individual parameter outputted. Here, the first individual parameter is an image quality adjustment parameter that changes in response to changes in the common parameter, and the second individual parameter is a sound quality adjustment parameter that changes in response to changes in the common parameter.

A program according to further another aspect of the present disclosure is a program that causes a computer to execute: accepting an input of a common parameter associated with a plurality of individual parameters; outputting a first individual parameter and a second individual parameter that are associated with the common parameter inputted, among the plurality of individual parameters; adjusting image quality in accordance with the first individual parameter outputted; and adjusting sound quality in accordance with the second individual parameter outputted. Here, the first individual parameter is an image quality adjustment parameter that changes in response to changes in the common parameter, and the second individual parameter is a sound quality adjustment parameter that changes in response to changes in the common parameter.

The recording medium according to further another aspect of the present disclosure is a non-transitory computer-readable recording medium which stores a control program, the recording medium being a nonvolatile recording medium that causes a processor to execute: accepting an input of a common parameter associated with a plurality of individual parameters; outputting a first individual parameter and a second individual parameter that are associated with the common parameter inputted, among the plurality of individual parameters; adjusting image quality in accordance with the first individual parameter outputted; and adjusting sound quality in accordance with the second individual parameter outputted. Here, the first individual parameter is an image quality adjustment parameter that changes in response to changes in the common parameter, and the second individual parameter is a sound quality adjustment parameter that changes in response to changes in the common parameter.

Note that these comprehensive or specific aspects may be implemented as a system, a device, a method, an integrated circuit, a computer program, or a computer-readable recording medium, or may be implemented as any combination of a system, a device a method, an integrated circuit, a computer program, and a recording medium. Examples of the computer-readable recording medium include a nonvolatile recording medium such as a compact disc-read only memory (CD-ROM).

### Advantageous Effects

The video/audio reproduction device and so forth according to the present disclosure facilitate viewer's adjusting image quality and sound quality to suit such viewer.

### BRIEF DESCRIPTION OF DRAWINGS

These and other objects, advantages and features of the disclosure will become apparent from the following description thereof taken in conjunction with the accompanying drawings that illustrate a specific embodiment of the present disclosure.

FIG. 1 is a diagram showing example statistical data of average television viewing time by age group.

FIG. 2 is a diagram showing example statistical data of aging-related decline in various physical functions.

FIG. 3A is a diagram showing example statistical data of aging-related decline in vision.

FIG. 3B is a diagram showing example statistical data of aging-related decline in hearing.

FIG. 4 is a diagram showing an exemplary functional configuration of a video/audio reproduction device according to Embodiment 1.

FIG. 5 is a diagram showing a relationship between a common parameter and individual parameters according to Embodiment 1.

FIG. 6 is a diagram showing an exemplary image quality adjustment parameter set.

FIG. 7 is a diagram showing an exemplary sound quality adjustment parameter set.

FIG. 8 is a diagram showing an exemplary functional configuration of a video/audio reproduction device according to Embodiment 2.

FIG. 9 is a diagram showing a relationship between common parameters and individual parameters according to Embodiment 2.

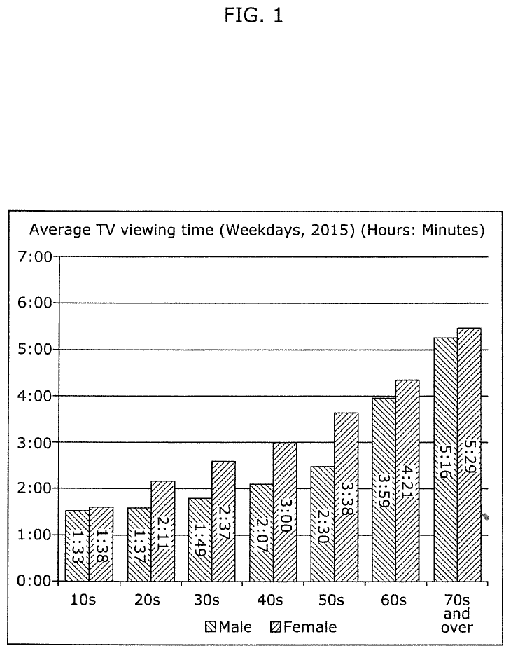

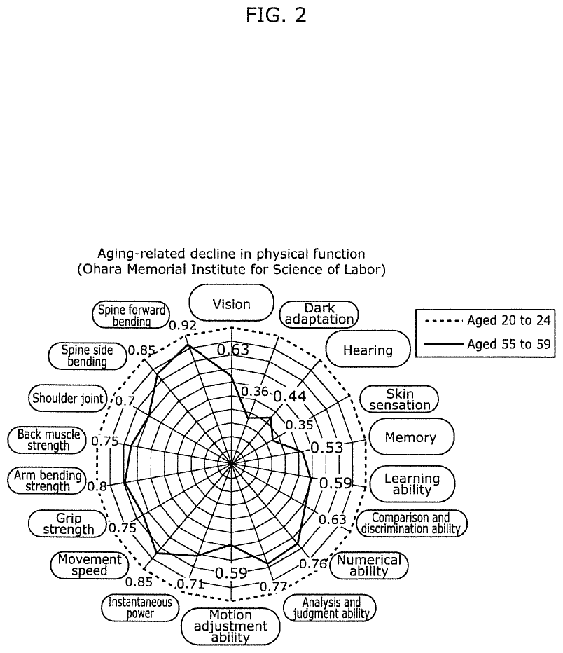

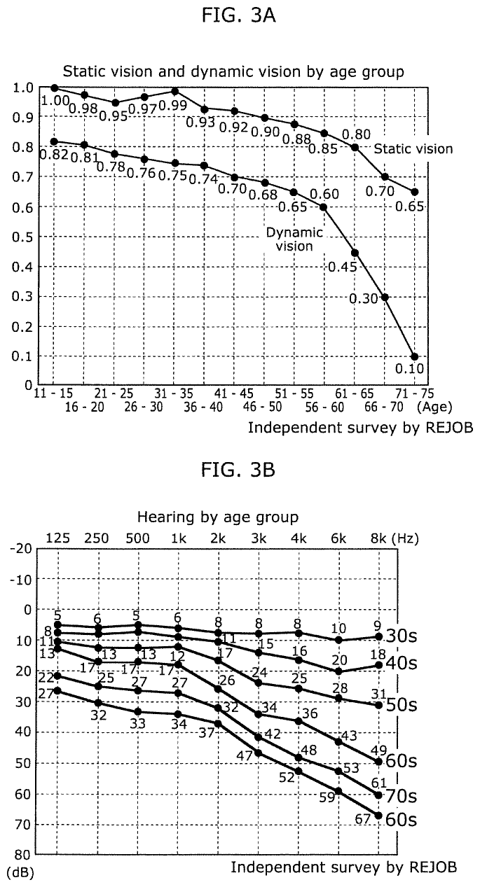

### DESCRIPTION OF EMBODIMENTS

As described in the section of “Background”, the inventors have studied the technologies for adjusting image quality and sound quality in accordance with the degree of aging of a viewer. The inventors have put a special focus on the technologies of PTL 1, PTL 2 and so forth to find that there is no technology for adjusting image quality and sound quality in conduction with each other to suit the physical condition of a viewer, and studied such technology. The inventors have conducted an intensive study to conceive a video/audio reproduction device and so forth as described below.

The video/audio reproduction device according to one aspect of the present disclosure is a video/audio reproduction device that adjusts a common parameter associated with a plurality of individual parameters to adjust image quality and sound quality, the video/audio reproduction device including: a parameter output unit that accepts an input of the common parameter and outputs a first individual parameter and a second individual parameter that are associated with the common parameter inputted, among the plurality of individual parameters; an image quality adjustment unit that adjusts the image quality in accordance with the first individual parameter outputted; and a sound quality adjustment unit that adjusts the sound quality in accordance with the second individual parameter outputted. Here, the first individual parameter is at least one image quality adjustment parameter that changes in response to changes in the common parameter, and the second individual parameter is at least one sound quality adjustment parameter that changes in response to changes in the common parameter.

According to the above aspect, the video/audio reproduction device accepts an input of the common parameter requested by the viewer, thereby adjusting the image and the sound to have image quality and sound quality requested by the user. This thus facilitates viewer's adjusting the image quality and the sound quality to suit such viewer.

In the video/audio reproduction device according to one aspect of the present disclosure, the common parameter may include a first common parameter associated with the first individual parameter and a second common parameter associated with the second individual parameter, and the parameter output unit may accept inputs of the first common parameter and the second common parameter, and output the first individual parameter associated with the first common parameter inputted and the second individual parameter associated with the second common parameter inputted.

According to the above aspect, the video/audio reproduction device accepts inputs of the first common parameter and the second common parameter requested by the viewer, thereby individually adjusting the image and the sound to have image quality and sound quality requested by the user. This thus enables the viewer to individually adjust the image quality and the sound quality to suit such viewer.

In the video/audio reproduction device according to one aspect of the present disclosure, the common parameter may be a parameter representing an age level of a target viewer.

According to the above aspect, the age of the viewer serves as the criterion for determining the common parameter. This thus enables the viewer to easily set the common parameter in accordance with the physical condition of such viewer.

In the video/audio reproduction device according to one aspect of the present disclosure, the first individual parameter may be an image quality adjustment parameter that changes the image quality to compensate for an aging-related decline in vision, the second individual parameter may be a sound quality adjustment parameter that changes the sound quality to compensate for an aging-related decline in hearing, and the first individual parameter and the second individual parameter may change in conjunction with each other in response to changes in the common parameter.

The above aspect enables the settings of the image quality adjustment parameter and the sound quality adjustment parameter to, for example, raise the degrees to which the image quality adjustment parameter compensates for an aging-related decline in vision and the sound quality adjustment parameter compensates for an aging-related decline in hearing as the age level corresponding to the value of the common parameter increases. The video/audio reproduction device compensates for an aging-related decline in vision and hearing, thereby enabling the image quality adjustment and the sound quality adjustment to suit the video/audio viewing by the elderly.

In the video/audio reproduction device according to one aspect of the present disclosure, the first individual parameter may be a parameter that increases or decreases at least one of a luminance gradation, a luminance contour, and a color tone concerning the image quality, at least one of the luminance gradation, the luminance contour, and the color tone may be increased or decreased to cover an extent that impairs the image quality perceivable by a viewer with normal vision, and the second individual parameter may be a parameter that increases or reduces a dynamic range concerning the sound quality.

According to the above aspect, the first individual parameter is adjusted to cover an extent that impairs the image quality perceivable by a viewer with normal vision. Such extent being associated with levels of the image quality perceivable by the elderly, the first individual parameter achieves image quality that suits the respective age groups from the youth to the elderly. This thus enables a wider range of viewers to use the video/audio reproduction device.

In the video/audio reproduction device according to one aspect of the present disclosure, the parameter output unit may increase or decrease the first individual parameter as the age level represented by the common parameter increases, and the parameter output unit may increase or decrease the second individual parameter as the age level represented by the common parameter increases.

According to the above aspect, the first individual parameter and the second individual parameter monotonically increase or decrease with an increase or a decrease in the age level. This thus enables the first individual parameter and the second individual parameter to be associated with the age level in a reliable and easy manner. This configuration also enables the viewer to perceive smooth changes in the image quality and the sound quality that occur by increasing or decreasing the first individual parameter and the second individual parameter.

In the video/audio reproduction device according to one aspect of the present disclosure, the parameter output unit may change the first individual parameter to a degree that impairs the image quality perceivable by a viewer with normal vision as the age level represented by the common parameter increases, and the parameter output unit may change the second individual parameter to a degree that impairs the sound quality perceivable by a viewer with normal hearing as the age level represented by the common parameter increases.

In the above aspect, the first individual parameter and the second individual parameter can be changed to degrees that affect the visual and hearing perception of a viewer with normal vision or a viewer with normal hearing. For example, a degree that impairs the image quality perceivable by a viewer with normal vision and a degree that impairs the sound quality perceivable by a viewer with normal hearing may be defined as degrees that affect the visual and hearing perception of the young (e.g., an extent that gives an unpleasant feeling to a young viewer) while not affecting the elderly. In such case, the parameter output unit is capable of outputting the first individual parameter and the second individual parameter that suit the respective age groups from the youth to the elderly.

In the video/audio reproduction device according to one aspect of the present disclosure, the first individual parameter may include the at least one image quality adjustment parameter comprising a plurality of image quality adjustment parameters, and the second individual parameter may include the at least one sound quality adjustment parameter comprising a plurality of sound quality adjustment parameters.

According to the above aspect, the video/audio reproduction device adjusts a plurality of image quality adjustment parameters to adjust the image quality and adjusts a plurality of sound quality adjustment parameters to adjust the sound quality. This achieves the image quality adjustment and sound quality adjustment that faithfully reflect the details of the common parameter and suit the viewer.

The video/audio reproduction method according to another aspect of the present disclosure includes: accepting an input of a common parameter associated with a plurality of individual parameters; outputting a first individual parameter and a second individual parameter that are associated with the common parameter inputted, among the plurality of individual parameters; adjusting image quality in accordance with the first individual parameter outputted; and adjusting sound quality in accordance with the second individual parameter outputted. Here, the first individual parameter is an image quality adjustment parameter that changes in response to changes in the common parameter, and the second individual parameter is a sound quality adjustment parameter that changes in response to changes in the common parameter. This aspect achieves a similar effect as that of the video/audio reproduction device according to one aspect of the present disclosure.

The program according to further another aspect of the present disclosure is a program that causes a computer to execute: accepting an input of a common parameter associated with a plurality of individual parameters; outputting a first individual parameter and a second individual parameter that are associated with the common parameter inputted, among the plurality of individual parameters; adjusting image quality in accordance with the first individual parameter outputted; and adjusting sound quality in accordance with the second individual parameter outputted. Here, the first individual parameter is an image quality adjustment parameter that changes in response to changes in the common parameter, and the second individual parameter is a sound quality adjustment parameter that changes in response to changes in the common parameter. This aspect achieves a similar effect as that of the video/audio reproduction device according to one aspect of the present disclosure.

The recording medium according to further another aspect of the present disclosure is a recording medium which stores a control program, the recording medium being a nonvolatile recording medium that causes a processor to execute: accepting an input of a common parameter associated with a plurality of individual parameters; outputting a first individual parameter and a second individual parameter that are associated with the common parameter inputted, among the plurality of individual parameters; adjusting image quality in accordance with the first individual parameter outputted; and adjusting sound quality in accordance with the second individual parameter outputted. Here, the first individual parameter is an image quality adjustment parameter that changes in response to changes in the common parameter, and the second individual parameter is a sound quality adjustment parameter that changes in response to changes in the common parameter. This aspect achieves a similar effect as that of the video/audio reproduction device according to one aspect of the present disclosure.

The following describes in detail the embodiments according to the present disclosure with reference to the drawings. Note that all of the following embodiments show a concrete example of the present disclosure. The numerical values, shapes, materials, structural components, the arrangement and connection of the structural components, usage procedure, communication procedure and so forth shown in the following embodiments are mere examples, and thus are not intended to limit the present disclosure. Of the structural components described in the following embodiments, structural components not recited in any one of the independent claims that indicate the broadest concepts of the present disclosure will be described as optional structural components. Note that the drawings are not necessarily precise illustrations. Structural components that are substantially identical are assigned with the same reference marks throughout the drawings, and their description may be omitted or simplified.

### Embodiment 1

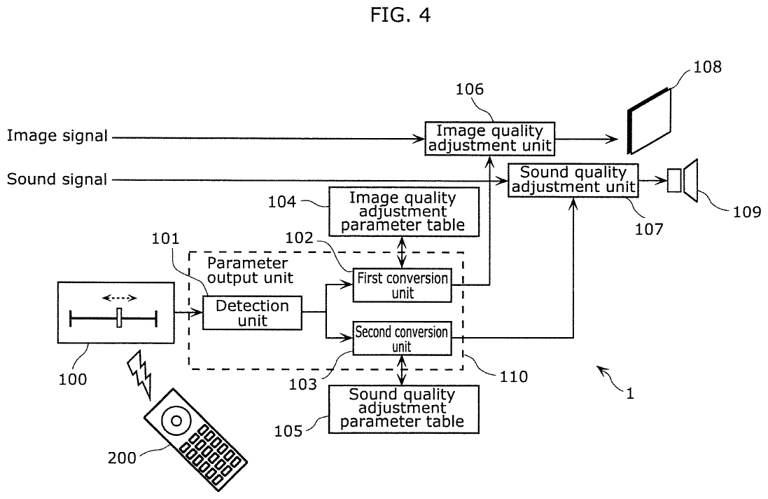

A video/audio reproduction device 1 according to Embodiment 1 will be described. FIG. 4 shows an exemplary functional configuration of the video/audio reproduction device 1 according to Embodiment 1. As shown in FIG. 4, the video/audio reproduction device 1 adjusts an image signal and a sound signal inputted to an image display panel 108 and a speaker 109, respectively, and outputs the resulting image signal and sound signal to the image display panel 108 and the speaker 109, respectively. An exemplary device including the image display panel 108 and the speaker 109 is a digital television receiver. Examples of the image display panel 108 include a liquid crystal panel, an organic or inorganic electroluminescence (EL) panel. The video/audio reproduction device 1 according to the present embodiment accepts a remote operation by a remote control 200, but the present embodiment is not limited to this. Examples of a wireless communication between the video/audio reproduction device 1 and the remote control 200 include an infrared communication and a radio wave communication.

The video/audio reproduction device 1 includes a user interface unit 100, a detection unit 101, a first conversion unit 102, a second conversion unit 103, an image quality adjustment parameter table 104, a sound quality adjustment parameter table 105, an image quality adjustment unit 106, and a sound quality adjustment unit 107. The detection unit 101, the first conversion unit 102, and the second conversion unit 103 constitute a parameter output unit 110.

The user interface unit 100 enables the user to adjust and set a common parameter associated with image quality adjustment parameters and sound quality adjustment parameters to be described later. The user interface unit 100 is operated via at least one of: a device that includes the image display panel 108 and/or the speaker 109; and the remote control 200. The user interface unit 100 obtains information inputted by the user into at least one of the device that includes the image display panel 108 and/or the speaker 109, and the remote control 200, and outputs a signal corresponding to the obtained information to the detection unit 101. An example of such information is information on the common parameter.

Such user interface unit 100 may be implemented as: a display image to be displayed on the image display panel 108; a display panel of the remote control 200; or a display image to be displayed on a display panel of the remote control 200. In these cases, the user interface unit 100 changes the display image in accordance with information inputted by the user via, for example, the device including the image display panel 108 and/or the speaker 109 and the remote control 200, and outputs the resulting signal corresponding to such information. Alternatively, the user interface unit 100 may be implemented as a physical operation device such as a switch, a button, a dial, and a slider arranged in the device that includes the image display panel 108 and/or the speaker 109 or in the remote control 200. In this case, the user interface unit 100 outputs a signal corresponding to an operation inputted by the user into the operation device.

The detection unit 101 detects the information on the common parameter specified via the user interface unit 100, and outputs the detection result to the first conversion unit 102 and the second conversion unit 103. The detection unit 101 detects the information on the common parameter from the information obtained from the user interface unit 100. Examples of the information on the common parameter include a value set to the common parameter. The common parameter according to the present embodiment is a parameter that represents the age level of a target viewer. The common parameter may be represented by a numerical value corresponding to an age level. For example, a greater value may be set to the common parameter as an age level increases.

The first conversion unit 102 converts the value of the common parameter detected by the detection unit 101 into an image quality adjustment parameter. More specifically, the first conversion unit 102 refers to a relationship, which is stored in the image quality adjustment parameter table 104, between the common parameter and the image quality adjustment parameter to determine a value of the image quality adjustment parameter corresponding to the value of the common parameter, and outputs the determined value to the image quality adjustment unit 106.

The second conversion unit 103 converts the value of the common parameter detected by the detection unit 101 into a sound quality adjustment parameter. More specifically, the second conversion unit 103 refers to a relationship, which is stored in the sound quality adjustment parameter table 105, between the common parameter and the sound quality adjustment parameter to determine a value of the sound quality adjustment parameter corresponding to the value of the common parameter, and outputs the determined value to the sound quality adjustment unit 107.

The image quality adjustment parameter table 104 and the sound quality adjustment parameter table 105 are capable of information storage and enable the reading of the information stored. The image quality adjustment parameter table 104 and the sound quality adjustment parameter table 105 are implemented, for example, as: a semiconductor memory such as a read-only memory (ROM), a random access memory (RAM), and a flash memory; and a recording device such as a hard disk drive and a solid state drive (SSD). The image quality adjustment parameter table 104 stores the value of an image quality adjustment parameter corresponding to the value of the common parameter. The sound quality adjustment parameter table 105 stores the value of a sound quality adjustment parameter corresponding to the value of the common parameter.

The image quality adjustment unit 106 adjusts the image quality of the image signal inputted to the image display panel 108, in accordance with the image quality adjustment parameter being the result outputted from the first conversion unit 102, and outputs the resulting image signal to the image display panel 108.

The sound quality adjustment unit 107 adjusts the sound quality of the sound signal inputted to the speaker 109, in accordance with the sound quality adjustment parameter being the result outputted from the second conversion unit 103, and outputs the resulting sound signal to the speaker 109.

The image display panel 108 displays the image signal adjusted by the image quality adjustment unit 106. The speaker 109 outputs the sound signal adjusted by the sound quality adjustment unit 107.

The structural components of the video/audio reproduction device 1, i.e., the user interface 100, the detection unit 101, the first conversion unit 102, the second conversion unit 103, the image quality adjustment unit 106, and the sound quality adjustment unit 107 may be implemented as a computer system (not illustrated) including a processor such as a central processing unit (CPU) and a digital signal processor (DSP), a RAM, a ROM and so forth. The function of one or more, or all of such structural components may be achieved by the CPU or the DSP executing a program recorded on the ROM by use of the RAM as a work memory. Also, the function of one or more, or all of such structural components may be achieved by a dedicated hardware circuit such as an electronic circuit and an integrated circuit. The function of one or more, or all of such structural components may be implemented by a combination of the software function and the hardware circuit described above. The program may be recorded in the ROM in advance, or may be provided as an application over a communication via a communication network such as the Internet, a communication compliant with a mobile communication standard, or other wireless/wired network, as well as over broadcasting and so forth.

Also, the user interface unit 100 and the parameter output unit 110 may be mounted on the same device or on separate devices. In the latter case, the user interface unit 100 and the parameter output unit 110 may be connected to each other over a wireless communication. Also, the parameter output unit 110, the image quality adjustment unit 106, and the sound quality adjustment unit 107 may be mounted on the same device or on separate devices. In the latter case, the parameter output unit 110 and the image quality adjustment unit 106, and the parameter output unit 110 and the sound quality adjustment unit 107, respectively, may be connected to each other over a wireless communication. Examples of the wireless communication include an infrared communication and a radio wave communication. Examples of the radio wave communication include a Near Field Communication such as Bluetooth® and ZigBee®, and a wireless local area network (LAN) such as wireless fidelity (WI-Fi®).

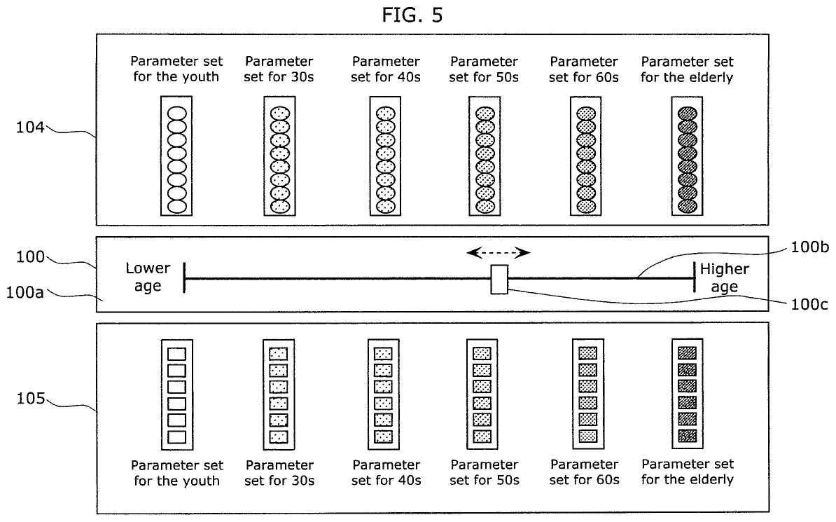

The following describes in detail the common parameter and individual parameters. The common parameter is associated with a plurality of individual parameters. An image quality adjustment parameter is an exemplary first individual parameter among the plurality of individual parameters, and a sound quality adjustment parameter is an exemplary second individual parameter among the plurality of individual parameters. FIG. 5 shows a relationship between the common parameter and the individual parameters. FIG. 5 shows in the middle of the diagram an exemplary display portion in the user interface unit 100 showing the common parameter. A display portion 100a shown in FIG. 5 may be implemented as: an image for displaying the common parameter; a display panel that displays the common parameter in the form of an image; or a physical operation device that operates in conjunction with changes in the common parameter. The common parameter according to the present embodiment is the age of a user (viewer) represented as a parameter in ascending or descending order. In other words, the common parameter is the age level of a user represented as a parameter. The common parameter changes along an age axis 100b. To simplify the illustration, the starting point of the age axis 100b is represented as “lower age” and the endpoint as “higher age”. The display portion 100a includes the age axis 100b and a slider 100c that moves along the age axis 100b. The user interface unit 100 causes the slider 100c to move along the age axis 100b in accordance with an instruction inputted by the user into the user interface unit 100.

FIG. 5 shows in the upper part of the diagram an exemplary table stored in the image quality adjustment parameter table 104. This table stores the image quality adjustment parameters constituting the first individual parameter as indices representing the age levels of a user. The table stores in advance image quality adjustment parameters corresponding to the common parameter on a user's age level basis. The table stores such image quality adjustment parameters in association with the common parameter. In the present embodiment, the age levels are not represented by consecutive variables but by indices that are generated by segmenting the age brackets from the youth to the elderly into a plurality of levels, although the present embodiment is not limited to such representation. More specifically, the age levels are segmented into age groups to be represented by indices of “the youth”, “30s”, “40s”, “50s”, “60s”, and “the elderly”. Note that the age levels may be represented by consecutive variables. Also note that the display portion 100a may show the indices of the respective age levels on the age axis 100b. In the present description, “the elderly” and “elderly people” refer to the age group of those who in their 60s and over and the people belonging to such age group. However, the target ages of the elderly and elderly people are not limited to 60s and over.

Image quality adjustment parameters are set to the respective indices. More specifically, an image quality adjustment parameter set including a plurality of image quality adjustment parameters is set to each of the indices. Furthermore, a plurality of parameters for image quality adjustment that are prepared to suit the characteristics of an average eyesight of a user in the age group corresponding to each of the indices are set to each of the indices.

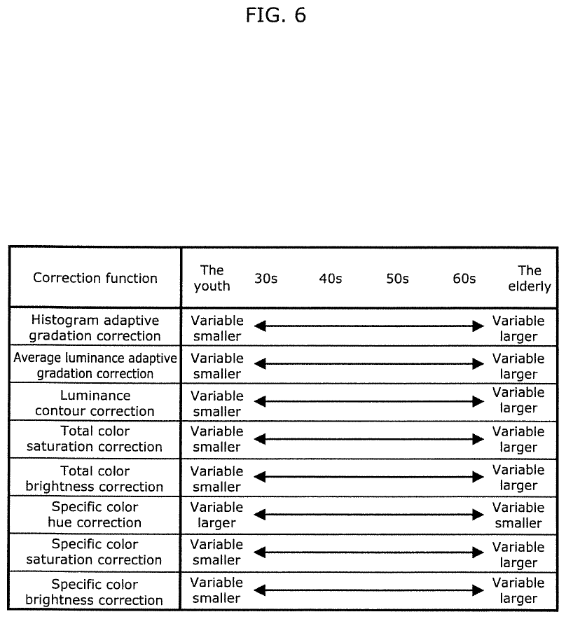

For example, FIG. 6 shows an exemplary image quality adjustment parameter set. Variable values of the respective image quality adjustment parameters described below are set to the indices to suit the characteristics of the eyesight of the respective age groups. Such image quality adjustment parameters are: histogram adaptive gradation correction; average luminance adaptive gradation correction; luminance contour correction; total color saturation correction; total color brightness correction; specific color hue correction; specific color saturation correction; and specific color brightness correction. Each image quality adjustment parameter set includes at least one of these image quality adjustment parameters. Here, histogram adaptive gradation correction and average luminance adaptive gradation correction are examples of the increase and decrease of the luminance gradation. Luminance contour correction is an example of the increase and decrease of the luminance contour. Total color saturation correction, total color brightness correction, specific color hue correction, specific color saturation correction, and specific color brightness correction are examples of the increase and decrease of the color tone. Note that to suit the characteristics of the eyesight of an age group means that an image is easy to see for a user belonging to such age group. As shown in FIG. 6, the values of the image quality adjustment parameters monotonically increase or decrease as the age level increases. Such image quality adjustment parameters serve to change the image quality to compensate for an aging-related decline in the user's vision.

The values of the image quality adjustment parameters included in the respective image quality adjustment parameter sets turn to excessive values that change the image quality perceivable by a user with normal vision to a degree that impairs the image quality, as the indices shift toward the elderly. The image quality provided by such values of the image quality adjustment parameters is an unacceptable level when, for example, the image quality of a conventionally commercialized television receiver is considered.

FIG. 5 shows in the lower part of the diagram an exemplary table stored in the sound quality adjustment parameter table 105. This table stores the sound quality adjustment parameters constituting the second individual parameter as indices representing the age levels of the user. The table stores in advance sound quality adjustment parameters corresponding to the common parameter on a user's age level basis. The table stores such sound quality adjustment parameters in association with the common parameter. In the present embodiment, the age levels corresponding to the sound quality adjustment parameters are represented by indices similar to those of the image quality adjustment parameters, although the present embodiment is not limited to such representation. Note that the age levels may be represented by consecutive variables.

Sound quality adjustment parameters are set to the respective indices. More specifically, a sound quality adjustment parameter set including a plurality of sound quality adjustment parameters is set to each of the indices. Furthermore, a plurality of parameters for sound quality adjustment that are prepared to suit the characteristics of an average hearing of a user in the age group corresponding to each of the indices are set to each of the indices. More specifically, each sound quality adjustment parameter set may include, for example, a filter coefficient for correcting the perceptual sensitivity to high-frequency components that declines with increasing aging, and may include parameters prepared on an age group basis to suit the degree of compression in dynamic range compression for correcting over-recruitment that occurs with increasing aging.

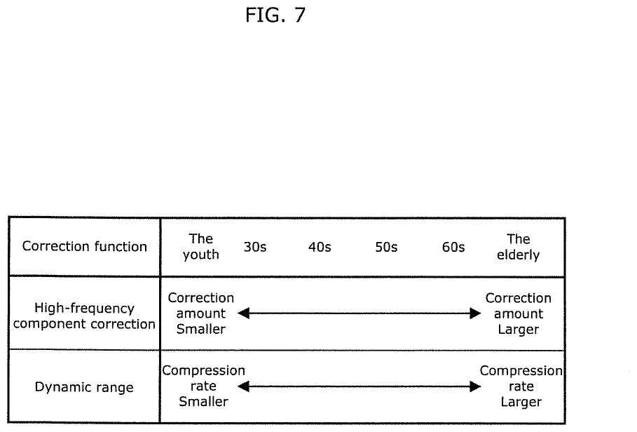

For example, FIG. 7 shows an exemplary sound quality adjustment parameter set. Variable values of the respective sound quality adjustment parameters described below are set to the indices to suit the characteristics of the hearing of the respective age groups. Such sound quality adjustment parameters are: a filter coefficient for correcting high-frequency components; and a rate of compressing the dynamic range of a sound pressure. Each sound quality adjustment parameter set includes at least one of these sound quality adjustment parameters. To increase or decrease the dynamic range here means to decrease or increase the rate of compressing the dynamic range. Note that to suit the characteristics of the hearing of an age group means that sound is easy to hear for a user belonging to such age group. As shown in FIG. 7, the values of the sound quality adjustment parameters monotonically increase or decrease as the age level increases. Such sound quality adjustment parameters serve to change the sound quality to compensate for an aging-related decline in the user's hearing. The sound quality adjustment parameters change together with the image quality adjustment parameters in conjunction with each other in response to changes in the age level, i.e., changes in the common parameter.

The values of the sound quality adjustment parameters included in the respective sound quality adjustment parameter sets turn to excessive values that change the sound quality perceivable by a user with normal hearing to a degree that impairs the sound quality, as the indices shift toward the elderly. The sound quality provided by such values of the sound quality adjustment parameters is an unacceptable level when, for example, the sound quality of a conventionally commercialized television receiver is considered.

With reference to FIG. 4 and FIG. 5, the operation of the video/audio reproduction device 1 with the above configuration will be described. First, the user sets the common parameter to the age level of the user by use of the user interface unit 100. Stated differently, the user moves the slider 100c of the display portion 100a to the position corresponding to the age level of such user. When at the age of 20, for example, the user is simply required to place the slider 100c to the position of “the youth”, which is the starting point of the parameter. When at the age of 70, the user is simply required to move the slider 100c rightward in the diagram near to the position of “the elderly”, which is the endpoint. The user is not required to set the slider 100c to the position that reflects the actual age of such user, and thus may set the slider 100c on the basis of the user's awareness of his/her own age.

To simplify the illustration, the display portion 100a in FIG. 5 represents the starting point of the age axis 100b as “lower age” and the endpoint as “higher age”, but the present embodiment is not limited to such representation. Instead of providing a particular name to the starting point, the message saying, “specify your age level” and an arrow pointing toward the endpoint may be displayed. Alternatively, the display portion 100a may be configured to directly accept the specification of an age per se. In this case, an image quality adjustment parameter set and a sound quality adjustment parameter set may be defined by use of each age as an index.

Alternatively, instead of using numerical values that represent ages per se or expressions that invoke the images of ages in the display portion 100a, expressions that represent the states of the image quality and the sound quality may be used. For example, in FIG. 5, the starting point represented as “lower age” may be described by an adjective “clearly”, and the endpoint represented as “higher age” may be described by an adjective “glistering”. In this case, the explanation of such adjectives may be described in the user's manual, etc. of the device that includes the display portion 100a and the image display panel 108 and/or the speaker 109. Such explanation may be described, for example, as “glistering images are recommended with increasing age” to prompt the user to set the slider 100c in accordance with increasing age.

Note that although FIG. 4 illustrates the user interface unit 100 in a different position from that of the image display panel 108, the image display panel 108 may display a settings screen similar to the display portion 100a shown in FIG. 5. Also, the settings screen may be operated through the remote control 200. The remote control 200 may be a remote control attached to the image display panel 108.

The user interface unit 100 is described as setting the common parameter by controlling the position of the slider 100c that slides to the right and left as shown in FIG. 5, but the present embodiment is not limited to this. Instead of using the slider 100c, the user interface unit 100 may use an icon that invokes the image of a rotating “knob”. In this case, the user interface unit 100 may set the common parameter in accordance with the position of such icon rotated to the right or left.

Next, the detection unit 101 obtains the position of the slider 100c from the user interface unit 100 to detect the value of the common parameter corresponding to the obtained position. As shown by the display portion 100a in FIG. 5, the present explanation assumes that the position of the slider 100c has been set slightly toward “higher age” with respect to the center of the age axis 100b.

Next, the first conversion unit 102 refers to the image quality adjustment parameter table 104, thereby converting the value of the common parameter detected by the detection unit 101 into image quality adjustment parameters, or more specifically, into an image quality adjustment parameter set. The first conversion unit 102 uses as an index the value of the common parameter corresponding to the position of the slider 100c on the age axis 100b to select, from the image quality adjustment parameter table 104, an image quality adjustment parameter set corresponding to such index, and outputs the selected image quality adjustment parameter set to the image quality adjustment unit 106.

When the indices corresponding to a plurality of image quality adjustment parameter sets do not include the index that matches the value of the common parameter corresponding to the position of the slider 100c, for example, the first conversion unit 102 selects an index that is closest to the value of the common parameter to determine the image quality adjustment parameter set corresponding to such selected index. In an example of FIG. 5, the position of the slider 100c matches none of the positions of the image quality adjustment parameter sets, and thus the first conversion unit 102 selects the image quality adjustment parameter set for 50s that is closest to the position of the slider 100c. The index of the image quality adjustment parameter set for 50s selected is also an index that is closest to the value of the common parameter. Alternatively, the first conversion unit 102 may select at least two indices that are close to the value of the common parameter and interpolate image quality adjustment parameters by use of the image quality adjustment parameter sets corresponding to the selected indices, thereby calculating an image quality adjustment parameter set corresponding to the value of the common parameter. In an example of in FIG. 5, the first conversion unit 102 may interpolate image quality adjustment parameters by use of the image quality adjustment parameter sets for 40s, 50s, and 60s.

Note that as an index approaches closer to values representing higher ages, each image quality adjustment parameter associated with such index turns to an excessive value that changes the image quality perceivable by a viewer with normal vision to a degree that impairs the image quality. The video/audio reproduction device 1 may notify the user of the possibility of image quality impairment. For example, when the values of the image quality adjustment parameters corresponding to the common parameter set by the user reach a level that impairs the image quality perceivable by a viewer with normal vision or a higher level, the video/audio reproduction device 1 may, for example, change the color of the slider 100c or display a message indicating that values have reached the level that impairs the image quality.

After the detection performed by the detection unit 101, the second conversion unit 103 refers to the sound quality adjustment parameter table 105, thereby converting the value of the common parameter detected by the detection unit 101 into sound quality adjustment parameters, or more specifically, into a sound quality adjustment parameter set. The second conversion unit 103 uses as an index the value of the common parameter corresponding to the position of the slider 100c on the age axis 100b to select, from the sound quality adjustment parameter table 105, a sound quality adjustment parameter set corresponding to such index, and outputs the selected sound quality adjustment parameter set to the sound quality adjustment unit 107.

When the indices corresponding to a plurality of sound quality adjustment parameter sets do not include the index that matches the value of the common parameter corresponding to the position of the slider 100c, for example, the second conversion unit 103 selects an index that is closest to the value of the common parameter to determine the sound quality adjustment parameter set corresponding to such selected index. In an example of FIG. 5, the second conversion unit 103 selects the sound quality adjustment parameter set for 50s that is closest to the position of the slider 100c. The index of the sound quality adjustment parameter set for 50s selected is also an index that is closest to the value of the common parameter. Alternatively, the second conversion unit 103 may interpolate sound quality adjustment parameters by use of the sound quality adjustment parameter sets corresponding to at least two indices that are close to the value of the common parameter, thereby calculating a sound quality adjustment parameter set corresponding to the value of the common parameter. In an example of in FIG. 5, the second conversion unit 103 may interpolate sound quality adjustment parameters by use of the sound quality adjustment parameter sets for 40s, 50s, and 60s.

Note that as an index approaches closer to values representing higher ages, each sound quality adjustment parameter associated with such index turns to an excessive value that changes the sound quality perceivable by a viewer with normal hearing to a degree that impairs the sound quality. The video/audio reproduction device 1 may notify the user of the possibility of sound quality impairment. For example, the video/audio reproduction device 1 may, for example, change the color of the slider 100c or display a message indicating that values have reached the level that impairs the sound quality, as in the case of the image quality adjustment parameters.

The video/audio reproduction device 1 with the above configuration enables image quality and sound quality to be adjusted and set in a successive manner through the movement, etc. of the slider 100c over a normal adjustment range in which the image quality and the sound quality are not impaired and an excessive adjustment range in which the image quality or the sound quality is impaired. Such video/audio reproduction device 1 provides a user interface capable of coping with physical symptoms known as “aging-related decline” that occur constantly and continuously.

When the user actually views video/audio by the video/audio reproduction device 1 after setting the image quality adjustment parameter set and the sound quality adjustment parameter set in a manner described above, the image quality adjustment unit 106 adjusts the image quality of the image signal to be inputted, in accordance with the image quality adjustment parameter set obtained from the first conversion unit 102, and outputs the resulting image onto the image display panel 108. Here, a method of adjusting the image quality on the basis of the image quality adjustment parameters is a conventionally known method as described in PTL 1, for example, and thus will not be described in detail. At the same time, the sound quality adjustment unit 107 adjusts the sound quality of the sound signal to be inputted, in accordance with the sound quality adjustment parameter set obtained from the second conversion unit 103, and outputs the resulting sound to the speaker 109. Here, a method of adjusting the sound quality on the basis of the sound quality adjustment parameters is a conventionally known method as described in PTL 2, for example, and thus will not be described in detail.

As described above, the video/audio reproduction device 1 according to Embodiment 1 adjusts a common parameter associated with a plurality of individual parameters to adjust image quality and sound quality. The video/audio reproduction device 1 accepts an input of the common parameter and outputs an image quality adjustment parameter and a sound quality adjustment parameter that are associated with the common parameter inputted, adjusts the image quality in accordance with the image quality adjustment parameter outputted, and adjusts the sound quality in accordance with the sound quality adjustment parameter outputted. The image quality adjustment parameter and the sound quality adjustment parameter change in response to changes in the common parameter. The video/audio reproduction device 1 accepts an input of the common parameter requested by the viewer, thereby adjusting the image and the sound to have image quality and sound quality requested by the user. This thus facilitates viewer's adjusting the image quality and the sound quality to suit such viewer.

In the video/audio reproduction device 1 according to Embodiment 1, the common parameter is a parameter representing an age level of a target viewer. This thus enables the viewer to easily set the common parameter in accordance with the physical condition of such viewer, with the age of such viewer serving as the criterion for determining the common parameter.

In the video/audio reproduction device 1 according to Embodiment 1, the image quality adjustment parameter that changes the image quality to compensate for an aging-related decline in vision and the sound quality adjustment parameter that changes the sound quality to compensate for an aging-related decline in hearing change in conjunction with each other in response to changes in the common parameter. This configuration thus enables the settings of the image quality adjustment parameter and the sound quality adjustment parameter to raise the degrees to which the image quality adjustment parameter compensates for an aging-related decline in vision and the sound quality adjustment parameter compensates for an aging-related decline in hearing with an increase in the age level corresponding to the value of the common parameter. The video/audio reproduction device 1 compensates for an aging-related decline in vision and hearing, thereby enabling the image quality adjustment and the sound quality adjustment to suit the video/audio viewing by the elderly.

In the video/audio reproduction device 1 according to Embodiment 1, the image quality adjustment parameter is adjusted to cover an extent that impairs the image quality perceivable by a viewer with normal vision. Such extent being associated with levels of the image quality perceivable by the elderly, the image quality adjustment parameter achieves image quality that suits the respective age groups from the youth to the elderly. This thus enables a wider range of viewers to use the video/audio reproduction device 1.

In the video/audio reproduction device 1 according to Embodiment 1, the image quality adjustment parameter and the sound quality adjustment parameter monotonically increase or decrease with an increase or a decrease in the age level. This thus enables the image quality adjustment parameter and the sound quality adjustment parameter to be associated with the age level in a reliable and easy manner. This configuration also enables the viewer to perceive smooth changes in the image quality and the sound quality that occur by increasing or decreasing the image quality adjustment parameter and the sound quality adjustment parameter.

Furthermore, the image quality adjustment parameter and the sound quality adjustment parameter can be changed to degrees that impair the image quality and the sound quality perceivable by a viewer with normal vision and hearing, respectively, as the age level increases. For example, a degree that impairs the image quality perceivable by a viewer with normal vision and a degree that impairs the sound quality perceivable by a viewer with normal hearing may be defined as degrees that affect the visual and hearing perception of the young (e.g., an extent that gives an unpleasant feeling to a young viewer) while not affecting the elderly. In such case, the values of the image quality adjustment parameter and the sound quality adjustment parameter may be changed to suit the respective age groups from the youth to the elderly. The video/audio reproduction device 1 according to

Embodiment 1 adjusts a plurality of image quality adjustment parameters to adjust the image quality and adjusts a plurality of sound quality adjustment parameters to adjust the sound quality. This achieves the image quality adjustment and sound quality adjustment that faithfully reflect the details of the common parameter and suit the viewer.

### Embodiment 2

The video/audio reproduction device 1 according to Embodiment 1 determines image quality adjustment parameters and sound quality adjustment parameters, at the same time, corresponding to a single common parameter having been set. A video/audio reproduction device 2 according to Embodiment 2 is configured to accept the settings of two common parameters to determine image quality adjustment parameters and sound quality adjustment parameters.

For example, the video/audio reproduction device 1 according to Embodiment 1 adjusts the image quality and the sound quality in conjunction with each other on the assumption that the user's vision and hearing decline in a similar pattern as the user's age level increases. However, such assumption is merely based on an average state among many cases. The progression of aging-related decline in vision and hearing can differ from individual to individual. For example, while some people's eyesight is getting worse, they still have good hearing and the converse often happens. The following describes the video/audio reproduction device 2 according to Embodiment 2 that is capable of coping with such situations, focusing on differences from Embodiment 1.

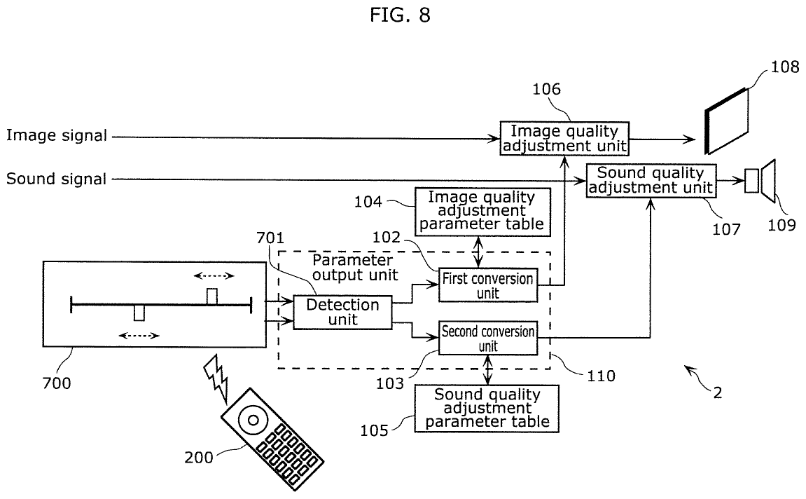

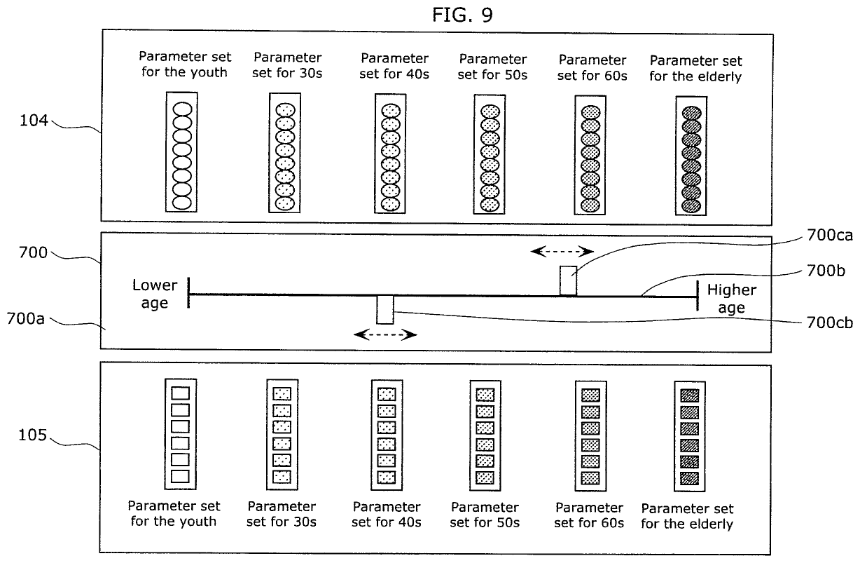

FIG. 8 shows an exemplary functional configuration of the video/audio reproduction device 2 according to Embodiment 2. FIG. 9 shows a relationship between common parameters and individual parameters according to Embodiment 2. As shown in FIG. 8 and FIG. 9, the configuration of the video/audio reproduction device 2 is similar to that of the video/audio reproduction device 1 according to Embodiment 1 except for a user interface unit 700 and a detection unit 701. The user interface unit 100 according to Embodiment 1 is configured to accept the setting of a single age level on the assumption that the user's vision and hearing have a similar declining pattern as the user's age level increases. The user interface unit 700 according to Embodiment 2 has the same age axis representing age levels as that of the user interface unit 100, but is capable of setting the age level concerning vision and the age level concerning hearing independently from each other. Consequently, while the number of outputs from the user interface unit 100 according to Embodiment 1 is one, the number of outputs from the user interface unit 700 according to Embodiment 2 is two.

As shown in FIG. 9, a display portion 700a of the user interface unit 700 includes an age axis 700b, sliders 700ca and 700cb that move along the age axis 700b. The user interface unit 700 causes the slider 700ca to move along the age axis 700b in accordance with an instruction concerning vision inputted by the user into the user interface unit 700. The user interface unit 700 also causes the slider 700cb to move along the age axis 700b in accordance with an instruction concerning hearing inputted by the user into the user interface unit 700. The position of the slider 700ca on the age axis . 700b indicates an age level of vision, and the position of the slider 700cb on the age axis 700b indicates an age level of hearing.

Also, the detection unit 101 according to Embodiment 1 is configured to support one input and one output to accept an output from the user interface unit 100, but the detection unit 701 according to Embodiment 2 is configured to support two inputs and two outputs to accept inputs from the user interface unit 700. The detection unit 701 detects the value of a first common parameter, which is the common parameter corresponding to the position of the slider 700ca, obtained from the user interface unit 700, and outputs the detected value to the first conversion unit 102. The detection unit 701 also detects the value of a second common parameter, which is the common parameter corresponding to the position of the slider 700cb, obtained from the user interface unit 700, and outputs the detected value to the second conversion unit 103. The first conversion unit 102 refers to the image quality adjustment parameter table 104, thereby determining an image quality adjustment parameter set on the basis of the value of the first common parameter. The second conversion unit 103 refers to the sound quality adjustment parameter table 105, thereby determining a sound quality adjustment parameter set on the basis of the value of the second common parameter. Such first common parameter is a common parameter associated with image quality adjustment parameters, and such second common parameter is a common parameter associated with sound quality adjustment parameters.

The other structural components and operation of the video/audio reproduction device 2 according to Embodiment 2 are similar to those according to Embodiment 1 and thus will not be described. The video/audio reproduction device 2 according to Embodiment 2 described above accepts the inputs of the first common parameter and the second common parameter requested by the viewer, thereby individually adjusting the image and the sound to have image quality and sound quality requested by the viewer. This configuration enables the viewer to individually set the age levels of vision and hearing of such viewer, thereby facilitating the adjustment of the image quality and the sound quality that more suit the individual.

### Others

The video/audio reproduction device according to one or more aspects has been described above on the basis of the embodiments, but the present disclosure is not limited to such embodiments. One or more aspects according to the present disclosure may include variations achieved by making various modifications and alternations to the embodiments that can be conceived by those skilled in the art without departing from the essence of the present disclosure, and an embodiment achieved by a combination of structural components of a different embodiment.

In the video/audio reproduction device according to each embodiment, the user interface unit associates a common parameter with the age level of the user, but the present disclosure is not limited to this. A common parameter may be associated, for example, with the progression of disease of vision and hearing. Furthermore, image quality adjustment parameters and sound quality adjustment parameters corresponding to the value of the common parameter may also be associated with the progression of disease of vision and hearing. The video/audio reproduction device with such configuration provides images and sound having image quality and sound quality that suit the progression of the user's disease.

In the above description, the video/audio reproduction device according to the embodiments is included in a digital television receiver, but a device including the video/audio reproduction device is not limited to a digital television receiver. The video/audio reproduction device may thus be included in any device capable of reproducing video and audio, such as a DVD player, a Blu-ray® Disc player, and a digital signage.

As mentioned above, the technology according to the present embodiment may be implemented as a system, a device, a method, an integrated circuit, a computer program, or a computer-readable recording medium such as a recording disk, or may be implemented as any combination of a system, a device a method, an integrated circuit, a computer program, and a recording medium. Examples of the computer-readable recording medium include a nonvolatile recording medium such as a CD-ROM.

For example, each of the structural components included in the embodiments may be implemented as a large-scale integration (LSI), which is an integrated circuit. The structural components may take the form of individual chips, or one or more or all of the structural components may be encapsulated into a single chip. Such ICs are not limited to LSI. Each of the structural components thus may be implemented as a dedicated circuit or a general-purpose processor. A field programmable gate array (FPGA) that allows for programming after the manufacture of an LSI, or a reconfigurable processor that allows for reconfiguration of the connection and the settings of circuit cells inside an LSI may be employed.

For example, one or more, or all of the above structural components may take the form of a removable integrated circuit (IC) card or a single module. The IC card or module is a computer system that includes a microprocessor, a ROM, a RAM, and so forth. Such IC card or module may include the above-described LSI or system LSI. The microprocessor operating in accordance with a computer program enables the IC card or module to achieve its function. Such IC card and module may be tamper resistant.

For example, the technology according to the present disclosure may be implemented as a software program or digital signals that form a software program, or may be a non-transitory, computer-readable recording medium on which a program is recorded. Such program can be distributed via a transmission medium such as the Internet.

The numerics used in the above description such as the ordinal number, quantity and so forth are all examples to specifically describe the technology according to the present disclosure, and thus the present disclosure is not limited to such example numerics. Also, the connection relationship among the structural components are mere examples to specifically describe the technology according to the present disclosure, and thus a connection relationship required to achieve the function of the present disclosure is not limited to such example connection relationship.

Also, the division of the functional blocks in the block diagrams is an example, and thus a plurality of functional blocks may be implemented as a single functional block, a single functional block may be divided into a plurality of blocks, or one or more functions may be moved to another functional block. Also, the functions of a plurality of functional blocks having similar functions may be processed by single hardware or software in parallel or in a time-shared manner.

Although only some exemplary embodiments of the present disclosure have been described in detail above, those skilled in the art will readily appreciate that many modifications are possible in the exemplary embodiments without materially departing from the novel teachings and advantages of the present disclosure. Accordingly, all such modifications are intended to be included within the scope of the present disclosure.

### INDUSTRIAL APPLICABILITY

The technology according to the present disclosure, which is capable of appropriately customizing images and sound to suit a viewer, is applicable for use in a reproduction device such as a television receiver, a DVD player, a Blu-ray® Disc player, and a digital signage.

1. A video/audio reproduction device that adjusts a common parameter associated with a plurality of individual parameters to adjust image quality and sound quality, the video/audio reproduction device comprising:
a parameter output unit that accepts an input of the common parameter and outputs a first individual parameter and a second individual parameter that are associated with the common parameter inputted, among the plurality of individual parameters;
an image quality adjustment unit that adjusts the image quality in accordance with the first individual parameter outputted; and
a sound quality adjustment unit that adjusts the sound quality in accordance with the second individual parameter outputted,
wherein the first individual parameter is at least one image quality adjustment parameter that changes in response to changes in the common parameter, and
the second individual parameter is at least one sound quality adjustment parameter that changes in response to changes in the common parameter.

2. The video/audio reproduction device according to claim 1,
wherein the common parameter includes a first common parameter associated with the first individual parameter and a second common parameter associated with the second individual parameter, and
the parameter output unit accepts inputs of the first common parameter and the second common parameter, and outputs the first individual parameter associated with the first common parameter inputted and the second individual parameter associated with the second common parameter inputted.

3. The video/audio reproduction device according to claim 1,
wherein the common parameter is a parameter representing an age level of a target viewer.

4. The video/audio reproduction device according to claim 3,
wherein the first individual parameter is an image quality adjustment parameter that changes the image quality to compensate for an aging-related decline in vision,
the second individual parameter is a sound quality adjustment parameter that changes the sound quality to compensate for an aging-related decline in hearing, and
the first individual parameter and the second individual parameter change in conjunction with each other in response to changes in the common parameter.

5. The video/audio reproduction device according to claim 4,
wherein the first individual parameter is a parameter that increases or decreases at least one of a luminance gradation, a luminance contour, and a color tone concerning the image quality,
at least one of the luminance gradation, the luminance contour, and the color tone is increased or decreased to cover an extent that impairs the image quality perceivable by a viewer with normal vision, and
the second individual parameter is a parameter that increases or reduces a dynamic range concerning the sound quality.

6. The video/audio reproduction device according to claim 3,
wherein the parameter output unit increases or decreases the first individual parameter as the age level represented by the common parameter increases, and
the parameter output unit increases or decreases the second individual parameter as the age level represented by the common parameter increases.

7. The video/audio reproduction device according to claim 6,
wherein the parameter output unit changes the first individual parameter to a degree that impairs the image quality perceivable by a viewer with normal vision as the age level represented by the common parameter increases, and
the parameter output unit changes the second individual parameter to a degree that impairs the sound quality perceivable by a viewer with normal hearing as the age level represented by the common parameter increases.

8. The video/audio reproduction device according to claim 1,
wherein the first individual parameter includes the at least one image quality adjustment parameter comprising a plurality of image quality adjustment parameters, and
the second individual parameter includes the at least one sound quality adjustment parameter comprising a plurality of sound quality adjustment parameters.

9. A video/audio reproduction method, comprising:
accepting an input of a common parameter associated with a plurality of individual parameters;
outputting a first individual parameter and a second individual parameter that are associated with the common parameter inputted, among the plurality of individual parameters;
adjusting image quality in accordance with the first individual parameter outputted; and
adjusting sound quality in accordance with the second individual parameter outputted,
wherein the first individual parameter is an image quality adjustment parameter that changes in response to changes in the common parameter, and
the second individual parameter is a sound quality adjustment parameter that changes in response to changes in the common parameter.

10. A non-transitory computer-readable recording medium which stores a control program, the recording medium being a nonvolatile recording medium that causes a processor to execute:
accepting an input of a common parameter associated with a plurality of individual parameters;
outputting a first individual parameter and a second individual parameter that are associated with the common parameter inputted, among the plurality of individual parameters;
adjusting image quality in accordance with the first individual parameter outputted; and
adjusting sound quality in accordance with the second individual parameter outputted,
wherein the first individual parameter is an image quality adjustment parameter that changes in response to changes in the common parameter, and
the second individual parameter is a sound quality adjustment parameter that changes in response to changes in the common parameter.
